(19) United States
(12) Patent Application Publication
(10) Pub. No.: US 2024/0061442 A1
(43) Pub. Date: Feb. 22, 2024

(54) Mobile Robot Positioning Method and System Based on Wireless Ranging Sensors, and Chip

(71) Applicant: AMICRO SEMICONDUCTOR CO.,LTD., Zhuhai, Guangdong (CN)

(72) Inventors: Qinwei LAI, Zhuhai, Guangdong (CN); Gangjun XIAO, Zhuhai, Guangdong (CN)

(21) Appl. No.: 18/269,574

(22) PCT Filed: Oct. 27, 2021
(86) PCT No.: PCT/CN2021/126770

§ 371 Date: Jun. 26, 2023

(30) Foreign Application Priority Data
Jan. 15, 2021 (CN) 202110054028.3

(51) Int. Cl. G05D 1/02; H04W 64/00; H04W 4/44

(52) U.S. Cl. CPC G05D 1/0272; G05D 1/028; G05D 1/0274; G05D 1/0225; H04W 64/00; H04W 4/44; G05D 2201/0203

(57) ABSTRACT

The present disclosure discloses a mobile robot positioning method and system based on wireless ranging sensors, and a chip. The mobile robot positioning method adopts a manner of controlling a mobile robot to traverse two target positions successively to acquire a distance between the mobile robot at each traversed position and a fixed positioning base station, rather than calculate distances between the robot at the same position and different base stations, such that the trouble of arranging a plurality of base stations in a positioning area is reduced.

### TECHNICAL FIELD

The present disclosure relates to the technical field of mobile robot navigation positioning, and more particularly relates to a mobile robot positioning method and system based on wireless ranging sensors, and a chip.

### BACKGROUND

Mobile robots with an autonomous navigation function, such as common home cleaning type floor cleaners have been rapidly developed in recent years. Current common slam technologies include visual navigation, laser navigation, inertial navigation, etc. The inertial navigation is widely applied to some low-end products due to its low cost, but has the problem of inaccurate global coordinate positioning.

On one hand, an inertial sensor is likely to accumulate non-systematic errors over time when a robot wheel set slips or moves on a carpet. For example, an odometer included in the inertial sensor is likely to accumulate drift errors over time in calculation of accurate navigation positions in a relatively short distance, resulting in uncontrollable positioning accuracy.

On the other hand, under some situations that a robot body is manually pushed, the inertial sensor can be utilized for calculating a rotating angle of the robot, but cannot calculate a real-time position or has a large deviation in calculation result.

In order to improve positioning and moving accuracy of the robot, in the Chinese patent No. CN111381586A, at least two ultra-wide band (UWB) base stations are arranged to calculate relative distances between the robot and the UWB base stations, and a robot coordinate position of the robot is calculated in combination with positions of the at least two UWB base stations, and is further required to be modified by fusing positioning information of the odometer; but at least two base stations are required to be arranged, which increases communication difficulty, and the coordinate angle calculated amount.

### SUMMARY

### Technical Problems

### Solutions for Problems

### Technical Solutions

Thus, based on inertial navigation, only one base station for wireless ranging is added in the technical solution of the present disclosure, which solves the problem that the inertial navigation is not high in positioning accuracy, and reduces the positioning data processing volume. The specific technical solution is as below: a mobile robot positioning method based on wireless ranging sensors includes: respectively calculating distances between two different positions where a mobile robot travels successively and a position of the same positioning base station through communication ranging of a first wireless ranging sensor arranged on the mobile robot and a second wireless ranging sensor arranged in the same positioning base station, where in the travel process of the mobile robot, a global map is constructed in the mobile robot in real time, and a global coordinate system is established on the global map based on a preset position of the positioning base station; calculating a latter position of the two different positions where the mobile robot travels successively based on the preset position of the positioning base station, the distances between the two different positions where the mobile robot travels successively and the position of the same positioning base station, and a numerical relationship which is between coordinate offsets of the two different positions where the mobile robot travels successively, and the numerical relationship is fed back by an odometer of the mobile robot, wherein the two different positions where the mobile robot travels successively are both within an effective detection range of the positioning base station.

Compared with the prior art, in order to obtain high-precision positioning data, the present technical solution adopts the manner of controlling the mobile robot to traverse two target positions successively to acquire a distance between the mobile robot at each traversed position and the fixed positioning base station, rather than calculate distances between the robot at the same position and different base stations, such that the trouble of arranging a plurality of base stations in a positioning area is reduced, it is unnecessary to receive, transmit and process communication instructions of two base stations at the same time, and meanwhile, there is no need to construct a geometrical relationship to calculate an angle relationship of the traversed positions of the robot relative to the positioning base station, thereby reducing the data processing volume, improving precision of real-time position coordinates of the mobile robot calculated based on the above distance, enhancing controllability, and avoiding influences from drift errors in the travel distance of the mobile robot fed back by the odometer in real time.

Further, the method of calculating the latter position of the two different positions where the mobile robot travels successively based on the preset position of the positioning base station, the distances between the two different positions where the mobile robot travels successively and the position of the same positioning base station, and a numerical relationship, fed back by an odometer of the mobile robot, between the coordinate offsets of the two different positions where the mobile robot travels successively specifically includes the steps: recording, by the odometer of the mobile robot, the coordinate offset of the final position of the actual travel path of the mobile robot relative to the start position, where the projection of the positioning base station on the travel plane of the mobile robot is the position of the positioning base station, the global coordinate system is established with the position of the positioning base station as the origin, and the coordinate offsets of the above two different positions include an X-axis coordinate offset and a Y-axis coordinate offset of the global coordinate system; and then, constructing a system of two-variable equations with coordinates of the final position as unknown quantities based on the distances between the two different positions where the mobile robot travels successively and the same positioning base station, and the coordinate offset of the final position relative to the start position so as to calculate the coordinates of the final position of the actual travel path of the mobile robot and determine the calculated position coordinates as the real-time coordinates of the mobile robot in the global map.

Compared with the prior art, in the present technical solution, the equation set with line segment distance information as parameter variables is constructed in the global coordinate system based on the coordinate offset of the final position of the actual travel path of the mobile robot relative to the start position and the distance information between the two positions and the positioning base station, so as to make the calculated coordinates of the final position of the actual travel path of the mobile robot as the real-time position coordinates of the mobile robot, such that the positioning accuracy is controllable in various robot travel paths, and the problem that an inertial sensor is large in positioning error in the global coordinate system is solved.

Further, the method further includes: fusing the coordinates of the final position of the actual travel path of the mobile robot calculated based on the above system of two-variable equations, the distance information measured by the odometer of the mobile robot and angle information measured by a gyroscope of the mobile robot to filter noise generated by the first wireless ranging sensor and the second wireless ranging sensor during communication ranging, thereby filtering the calculated coordinates of the final position of the actual travel path of the mobile robot, where a triangular geometric relationship is utilized for calculating inertial coordinates of the mobile robot in the inertial navigation process according to the distance information measured by the odometer of the mobile robot and the angle information measured by the gyroscope of the mobile robot to participate in filtering operation on the coordinates of the above final position. The positioning accuracy of the mobile robot is improved.

Further, a connecting line of the start position of the actual travel path of the mobile robot and the final position of the actual travel path of the mobile robot is parallel to a first preset coordinate axis direction. Calculation processing steps are simplified.

Further, when the first wireless ranging sensor is a UWB tag, the second wireless ranging sensor is a UWB base station. Compared with wireless positioning manners such as GPS and Zigbee, precision is higher, and cost is lower; and compared with an ultrasonic sensor, a signal detection angle is larger.

Further, in the process of communication ranging through the first wireless ranging sensor arranged on the mobile robot and the second wireless ranging sensor arranged in the positioning base station, if the calculated real-time coordinates of the mobile robot in the travel process are kept unchangeable, it is judged that the mobile robot is stuck, and then the odometer of the mobile robot is controlled to stop counting. The data processing volume can be reduced in the abnormal processing process.

Further, the positioning base station is further integrated with a charging base. Before the mobile robot positioning method is performed, if the mobile robot finishes dock charging on the charging base, the mobile robot is first controlled to leave the charging base in a second preset coordinate axis direction, and then, the mobile robot is controlled to rotate, such that a travel direction of the mobile robot is parallel to the first preset coordinate axis direction, where a first preset coordinate axis is perpendicular to a second preset coordinate axis. The robot smoothly leaves the base after finishing charging, so as to enter a positioning navigation mode.

Further, when the first preset coordinate axis is the X-axis, the second preset coordinate axis is the Y-axis, the first preset coordinate axis direction includes an X-axis positive direction or X-axis negative direction, and the second preset coordinate axis direction includes a Y-axis positive direction or Y-axis negative direction; and when the first preset coordinate axis is the Y-axis, the second preset coordinate axis is the X-axis, the first preset coordinate axis direction includes the Y-axis positive direction or Y-axis negative direction, and the second preset coordinate axis direction includes the X-axis positive direction or X-axis negative direction The application scenarios of the positioning method in the above technical solution are expanded, and the coordinate calculation complexity is reduced.

Further, the two different positions where the mobile robot travels successively are not located in a radial direction of a circular area with the positioning base station as the circle center. The phenomenon of large errors in the positioning operation process is avoided.

A mobile robot positioning system includes a mobile robot and a positioning base station. The mobile robot is provided with a first wireless ranging sensor and an odometer, and the positioning base station is integrated with a second wireless ranging sensor. The mobile robot inside further includes a distance calculation unit which is configured to respectively calculate distances between two different positions where the mobile robot travels successively and the same positioning base station through communication ranging of the first wireless ranging sensor arranged on the mobile robot and the second wireless ranging sensor arranged in the same positioning base station; and a coordinate position calculation unit which is configured to calculate coordinates of a latest position where the mobile robot travels based on the preset position of the positioning base station, the distances between the two different positions where the mobile robot travels successively and the same positioning base station, and a numerical relationship which is between coordinate offsets of the two different positions where the mobile robot travels successively, and the numerical relationship is fed back by an odometer of the mobile robot, and determine the calculated position coordinates as real-time coordinates of the mobile robot in a global map, where the two different positions where the mobile robot travels successively are both within an effective detection range of the positioning base station; the coordinates of the latest position where the mobile robot travels represent the latter of the two different positions where the mobile robot travels successively; and in the travel process of the mobile robot, the global map is constructed in the mobile robot in real time, and the global coordinate system is established on the global map based on the preset position of the positioning base station.

Compared with the prior art, in the present technical solution, a pair of wireless ranging sensors are added in a conventional inertial navigation system or recharge system, which solves the problems that positioning accuracy of inertial navigation is uncontrollable, and too many wireless base stations are arranged, and also reduces the position angle calculated amount; and the positioning system is implanted in the mobile robot, which is beneficial to improving positioning accuracy and navigation efficiency of the robot.

Further, the mobile robot is a visual robot or laser robot. The coordinate position calculation unit arranged inside is configured to construct a system of two-variable equations with coordinates of the final position as unknown quantities based on the distances between the two different positions where the mobile robot travels successively and the same positioning base station and the coordinate offset of the final position relative to the start position, calculate the coordinates of the final position of the actual travel path of the mobile robot, and determine the calculated coordinates of the final position as the coordinates of the latest position where the mobile robot travels; when the mobile robot travels at the two different positions successively, the odometer of the mobile robot is controlled to record the coordinate offset of the final position of the actual travel path of the mobile robot relative to the start position, where the position where the mobile robot starts to travel is the start position of the actual travel path of the mobile robot, and the latest position for travel is the final position of the actual travel path of the mobile robot; the projection of the positioning base station on the travel plane of the mobile robot is the position of the positioning base station, and the global coordinate system is established with the position of the positioning base station as the origin; and the coordinate offsets of the above two different positions include an X-axis coordinate offset and a Y-axis coordinate offset of the global coordinate system.

Compared with the prior art, in the present technical solution, the equation set with line segment distance information as parameter variables is constructed in the global coordinate system based on the coordinate offset of the final position of the actual travel path of the mobile robot relative to the start position and the distance information between the two positions and the positioning base station, so as to make the calculated coordinates of the final position of the actual travel path of the mobile robot as the real-time position coordinates of the mobile robot, such that the positioning accuracy is controllable in various robot travel paths, and the problem that an inertial sensor is large in positioning error in the global coordinate system is solved.

Disclosed is a chip. The chip is configured to store computer program code. The computer program code, when executed, implements the steps of the mobile robot positioning method based on wireless ranging sensors according to the embodiment. The positioning navigation accuracy of the mobile robot is controllable, and the coordinate position calculated amount is reduced.

Beneficial Effects of the Invention

### BRIEF DESCRIPTION OF THE DRAWINGS

### Brief Description of the Drawings

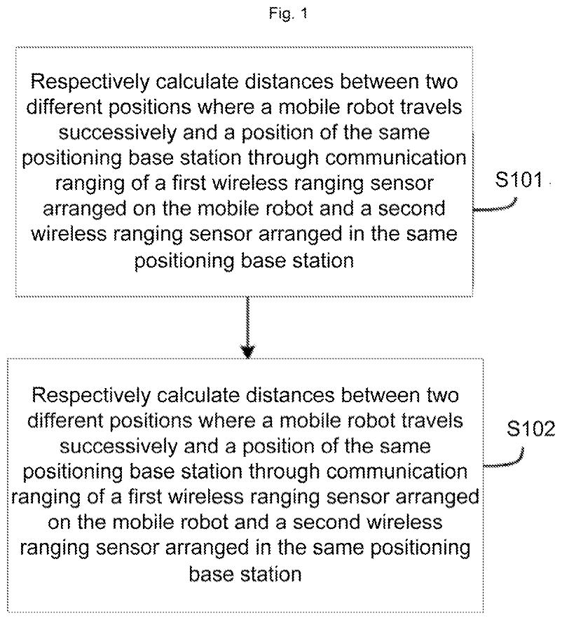

FIG. 1 is a flowchart of a mobile robot positioning method based on wireless ranging sensors according to an embodiment of the present disclosure.

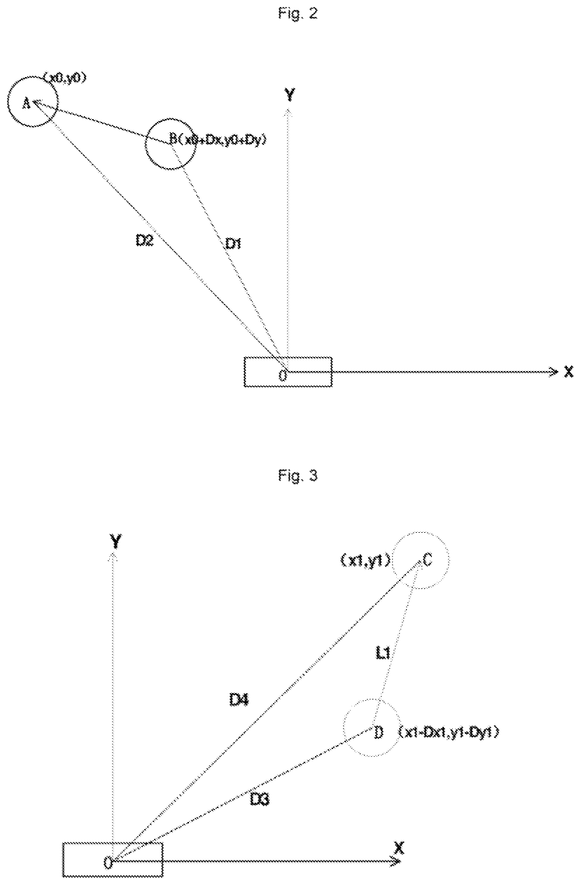

FIG. 2 is a schematic diagram of a mobile robot performing positioning calculation towards an area in an X-axis negative direction according to an embodiment.

FIG. 3 is a schematic diagram of a mobile robot performing positioning calculation towards an area in an X-axis positive direction according to an embodiment.

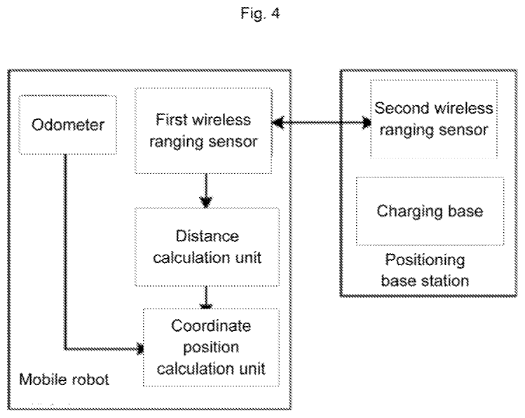

FIG. 4 is a schematic diagram of a framework of a mobile robot positioning system according to an embodiment of the present disclosure.

### EMBODIMENTS OF THE INVENTION

### Detailed Description of the Embodiments

Technical solutions in embodiments of the present disclosure are described in detail below in combination with drawings in the embodiments of the present disclosure.

An inertial navigation robot vacuum cleaner in the prior art usually uses an encoder disc in an odometer to count rotations of driving wheels, and if the driving wheels slip and bump due to a ground medium, as time goes on, the count value of the encoder disc has a large error relative to an actual travel distance of the robot, and as a result, a calculated pose, etc. of the robot have deviations, which are reflected in a map constructed by the robot in real time becoming tilted and unmatched with an original map; and even though laser radar or a visual camera is used, a result position obtained through scanning has a large deviation due to wheel self-rotation, slipping, etc. during real-time sampling, scanning and positioning, and seriously, the robot cannot re-position the self position, resulting in stop of the cleaner. In order to overcome the defect, in the Chinese patent No. CN111381586A, at least two UWB base stations are arranged to calculate relative distances between the robot and the UWB base stations, and a robot coordinate position of the robot is calculated in combination with positions of the at least two UWB base stations, but the at least two base stations are required to be arranged in a limited indoor environment, which has higher requirements for receiving and transmitting conditions of wireless communication, increases communication difficulty, and particularly, needs to avoid obstacles at more positions from influencing wireless communication signals; and meanwhile, usage of the plurality of base stations means an increase in the usage amount of parameters, resulting in an increase in the calculated amount for the coordinate distance and the angle pose.

Thus, based on the inertial navigation (travel distance information of a mobile robot recorded by an odometer), only one base station for wireless ranging is added in this embodiment of the present disclosure, which solves the problem that the inertial navigation is not high in positioning accuracy, simplifies a positioning processing method, and reduces the data processing volume. Specifically, a mobile robot positioning method based on wireless ranging sensors shown in FIG. 1, includes:

Step S101: Respectively calculate distances between two different positions where a mobile robot travels successively and a position of the same positioning base station through communication ranging of a first wireless ranging sensor arranged on the mobile robot and a second wireless ranging sensor arranged in the same positioning base station, and then perform step S102, where in the travel process of the mobile robot, a global map is constructed in the mobile robot in real time, a global coordinate system is established on the global map based on a preset position of the positioning base station, and meanwhile an odometer of the mobile robot is controlled to feed back the travel distance of the mobile robot in real time; and it should be noted that normal communication is unavailable after the distance between the mobile robot and the positioning base station exceeds a legal detection distance, the mobile robot cannot normally communicate when not within a legal detection view angle range of the positioning base station, as a result, position coordinates cannot be calculated, and thus, the two different positions where the mobile robot travels successively are both within the detection distance and the detection view angle range of the second wireless ranging sensor arranged in the positioning base station.

It is to be explained that the odometer of the mobile robot feeds back a coordinate offset of the mobile robot on an actual travel path, including a coordinate offset of an X-axis of the global coordinate system and a coordinate offset of a Y-axis of the global coordinate system. A projection of the positioning base station on a travel plane of the mobile robot is the position of the positioning base station, the position of the positioning base station is preset, and the positioning base station is generally arranged at open areas such as parallel walls and a long corridor area; and in this embodiment, the global coordinate system is established with the position of the positioning base station as an origin.

In this embodiment, every time when the mobile robot travels at two adjacent target positions successively, the first wireless ranging sensor arranged on the mobile robot and the second wireless ranging sensor arranged in the same positioning base station are controlled to be kept in communication ranging so as to respectively calculate the distances between the two adjacent target positions and the position of the positioning base station, where the mobile robot first traverses the first target position, and then traverses the adjacent second target position; and then, the mobile robot is controlled to continue to travel to a next adjacent third target position, and a relative distance between the third target position and the position of the same positioning base station is acquired through communication ranging of the second wireless ranging sensor in the same positioning base station.

Preferably, the two different positions where the mobile robot travels successively may be located at a front, rear, left or right end of the mobile robot or the positioning base station. Or, the two successively-traversed different positions include: a current position of the mobile robot and a position traversed before a preset time, or front-back positions corresponding to a reference linear distance that the mobile robot travels in a first preset coordinate axis direction, or two adjacent target positions set based on an obstacle distribution situation of a current movement area and a movement target of the mobile robot. The path where the mobile robot travels within the preset time, the path corresponding to the traversed reference linear distance in the first preset coordinate axis direction, and the above two adjacent target positions are all located within an effective detection range of the positioning base station, but the two different positions where the mobile robot travels successively are not located in a radial direction of a circular area with the position of the positioning base station as a circle center, that is, the two positions are not located in the radial direction of an outward radiating area of the positioning base station, thereby avoiding the phenomenon of too large errors in a positioning and operation process.

In this embodiment, the adjacent first target position and second target position and the adjacent second target position and third target position are all waypoints, the mobile robot starts to move from the preset position of the positioning base station according to the sequence of the waypoints and performs a positioning operation, coordinate information of the first target position traversed by the mobile robot, coordinate information of the second target position and coordinate information of the third target position are sequentially calculated, where when the mobile robot is located at the positioning base station, only the coordinate information of the position of the positioning base station is set, the coordinate information of the first target position, the coordinate information of the second target position and the coordinate information of the third target position are not preset, but the coordinate offset therebetween can be recorded by the odometer. These waypoints may be set according to the movement target of the mobile robot and obstacle arrangement positions in a movement scenario. A preferred distance between the adjacent target positions is a diameter length of a mobile robot body, or a preset multiple of the robot body diameter length so as to reflect that in a state of an obvious movement of the mobile robot, step S102 is performed to calculate coordinates of a latest position where the mobile robot travels, where a path corresponding to the preset multiple of the robot body diameter length cannot exceed the effective detection range of the positioning base station.

Step 102: Calculate the latter position of the two different positions where the mobile robot travels successively based on the preset position of the positioning base station, the distances between the two different positions where the mobile robot travels successively and the position of the same positioning base station, and a numerical relationship, fed back by the odometer of the mobile robot, between coordinate offsets of the two different positions where the mobile robot travels successively, preferably calculate coordinates of a latest position where the mobile robot travels when the mobile robot performs the positioning operation in the above embodiment at the current position, and determine the calculated position coordinates as real-time coordinates of the mobile robot in the global map. The two different positions where the mobile robot travels successively are both within the effective detection range of the positioning base station; the coordinates of the latest position where the mobile robot travels represent the latter of the two different positions where the mobile robot travels successively, and after the position coordinates of the latter in the two different positions where the mobile robot travels successively are acquired, position coordinates of the former of the two different positions where the mobile robot travels successively are calculated according to the coordinate offsets of the two different positions.

In a specific implementation scenario, the mobile robot first passes by the first target position, and the distance between the first target position and the position of the positioning base station can be acquired by performing step S101; after a period of time, the mobile robot passes by the second target position, and the distance between the second target position and the position of the same positioning base station can be acquired by performing step S101; and then step S102 is performed, a distance numerical relational expression is constructed based on the preset position of the positioning base station, the distance between the first target position and the position of the same positioning base station, the distance between the second target position and the position of the same positioning base station, and the coordinate offset, recorded by the odometer, of the second target position relative to the first target position in the global coordinate system, so as to calculate the position coordinates of the second target position, and then, the position coordinates of the first target position are calculated according to the above coordinate offset.

It is to be explained that when the mobile robot traverses the above two different positions along a preset reference path, a path actually traversed by the mobile robot may not be parallel to the first preset coordinate axis direction due to the factor of obstacle stop. In some implementation scenarios, a path actually traversed by the mobile robot is parallel to the first preset coordinate axis direction, and a latest position where the mobile robot travels is a final position of the preset reference path.

It is to be explained that in a conventional inertial navigation method, the coordinate position of the mobile robot in the global map can be calculated by combining the mobile robot travel distance measured by the odometer and a rotating angle of the mobile robot measured by a gyroscope, but as time goes on, the count value of the encoder disc has a large error relative to an actual travel distance of the robot, as a result, a calculated pose, etc. of the robot have deviations, and thus, it is not merely to use data of the odometer and the gyroscope for positioning calculation, but the distance information of the positions of the moving robot body and the positioning base station sampled by performing step S101 also participates in the positioning calculation in step S102.

In step S102, the preset coordinate position of the positioning base station in the global coordinate system of the mobile robot is regarded as origin coordinates. In this embodiment, to simplify coordinate calculation, the two different positions where the mobile robot travels successively may both have the coordinate offsets in the X-axis direction and the Y-axis direction, and the coordinates of the position where the mobile robot travels later are calculated according to a geometric vector relationship between lengths of connecting lines of the two positions and the origin and corresponding position coordinates. Specifically, the odometer of the mobile robot records the coordinate offset of the final position of the actual travel path of the mobile robot relative to the start position, where the projection of the positioning base station on the travel plane of the mobile robot is the position of the positioning base station, and the global coordinate system is established with the position of the positioning base station as the origin; the coordinate offsets of the above two different positions include the X-axis coordinate offset and the Y-axis coordinate offset of the global coordinate system; then, a distance equation with coordinates of the final position as unknown quantities is constructed based on a distance between the final position and the position of the positioning base station and the coordinate offset of the final position relative to the start position; meanwhile, the other distance equation with the coordinates of the same final position as unknown quantities is constructed based on a distance between the start position and the position of the positioning base station and the coordinate offset of the final position relative to the start position; then, final position coordinates of the actual travel path of the mobile robot are calculated by solving the two equations simultaneously and determined as coordinates of a latest position where the mobile robot travels, the position where travels starts in the two different positions where the mobile robot travels successively is the start position of the actual travel path of the mobile robot, and the latest travel position is the final position of the actual travel path of the mobile robot. In this embodiment, only the distance value is calculated without calculating distributed angle information of the final position of the actual travel path of the mobile robot relative to the positioning base station and distributed angle information of the start position of the actual travel path of the mobile robot relative to the positioning base station, such that the coordinate calculated amount and calculation complexity are reduced, positioning accuracy is controllable, and the problem that a positioning error of the inertial sensor in the global coordinate system is large, which is equivalent to correction of positioning coordinates calculated according to inertial data.

It should be noted that in some implementation scenarios, a connecting line of a starting point and a final point of a path actually traversed by the mobile robot may not be parallel to a coordinate axis direction, a length of the connecting line of the starting point and the final point may not be a fixed distance, but the coordinates of the latest position where the mobile robot travels may be calculated according to the distance between the starting point and the position of the same positioning base station and the distance between the final point and the position of the same positioning base station. In the other aspect, the distances between the two different positions where the mobile robot travels successively and the position of the same positioning base station are horizontal distances between the mobile robot at the two positions and the positioning base station. Ranging information received by the first wireless ranging sensor from the second wireless ranging sensor may be restrained by a height of the positioning base station, and thus the ranging information is required to be converted, by the Pythagorean theorem of a right triangle, into the distance between the mobile robot and the projection position of the positioning base station on the horizontal ground.

Compared with the prior art, in order to obtain high-precision positioning data, the present technical solution adopts the manner of controlling the mobile robot to traverse two target positions successively to acquire a distance between the mobile robot at each traversed position and a fixed positioning base station, rather than calculate distances between the robot at the same position and different base stations, such that the trouble of arranging a plurality of base stations in a positioning area is reduced, it is unnecessary to receive, transmit and process communication instructions of two base stations at the same time, and meanwhile, there is no need to construct a geometrical relationship to calculate an angle relationship of the traversed positions of the robot relative to the positioning base station, thereby reducing the data processing volume, improving precision of real-time position coordinates of the mobile robot calculated based on the above distance, enhancing controllability, and avoiding influences from drift errors in the travel distance of the mobile robot fed back by the odometer in real time.

Based on the above embodiment, the first wireless ranging sensor and the second wireless ranging sensor carry certain noise in a communication process, causing drift of ranging data, and thus, during practical application, fusion calculation by the odometer and the gyroscope is performed at the same time, which specifically includes the steps that after the mobile robot passes by the two different positions successively, the actual travel path of the mobile robot is generated, the coordinates of the final position of the actual travel path of the mobile robot calculated in step S102, the distance information measured by the odometer of the mobile robot and the angle information measured by the gyroscope of the mobile robot are fused to filter the coordinates of the final position of the actual travel path of the mobile robot, and the starting point and the final point are both related to traversed paths corresponding to the two different positions where the mobile robot travels successively, and belong to local start and stop position points. A specific fusion method includes the steps that according to the distance information measured by the odometer of the mobile robot and the angle information measured by the gyroscope of the mobile robot, inertial coordinates of the mobile robot are calculated by a triangular geometric relationship, then, the inertial coordinates of the mobile robot and the coordinates of the final point of the actual travel path of the mobile robot calculated in step S102 are input into a filtering model to participate in filtering operation of the coordinates of the above final position, the coordinates of the final position can be adjusted according to a difference of the two kinds of coordinates, so as to filter out the noise generated by the first wireless ranging sensor and the second wireless ranging sensor during communication ranging. Due to accumulative errors of the odometer, the position cannot be directly used as the real-time position in the inertial navigation process, but can serve as a reference estimated value to calculate an estimated error for the filtering operation. That is, the coordinates determined according to the ranging information of the wireless ranging sensors are further modified through the coordinates determined by the inertial sensor, such that higher-precision real-time coordinates of the mobile robot in the global map are obtained. The filtering model includes but not limited to filtering model algorithms such as a Kalman filtering model and a lowpass filtering model.

Preferably, when the first wireless ranging sensor is a UWB tag, the second wireless ranging sensor is a UWB base station, and a UWB is an ultra-wide band ranging sensor. Compared with wireless positioning manners such as GPS and Zigbee, precision is higher, and cost is lower; and compared with an ultrasonic sensor, a signal detection angle is larger. In some implementation scenarios, at time T1, the UWB base station (a slave device) in the positioning base station initiates a ranging request pulse to the UWB tag (a primary device) on the mobile robot. At time T2, the ranging request pulse arrives at the UWB tag on the mobile robot to finish one-time ranging. A flight time of the pulse between the UWB base station and the UWB tag is a result obtained after T2 minus T1. Given that a pulse movement velocity is approximate to a light velocity C, and thus, the distance between the current position of the mobile robot and the position of the positioning base station is D=C*(T2−T1). Thus, in the movement process of the mobile robot, the angle calculated by the gyroscope in the robot body and the travel distance information fed back by the odometer can be constantly acquired; and meanwhile the mobile robot continuously communicates with the positioning base station for calculating the distance information therebetween. Thus, in the movement process of the mobile robot, information acquired from the sensor includes a rotating angle, a travel distance, and a distance between the robot body and the position of the positioning base station.

As an embodiment, as shown in FIG. 2, a global coordinate system is established with the position of the positioning base station as an origin O, and when the mobile robot travels to an area pointed by an X-axis negative direction and uses one positioning base station at the origin for positioning, the position B (x0+Dx, y0+Dy) is a position traversed by the mobile robot, and the position A (x0, y0) is an expected target position reached by the mobile robot as the mobile robot starts to travel to the area in the X-axis negative direction from the position B. Firstly, the mobile robot at the position B communicates with the positioning base station at the position O through the wireless ranging sensor so as to obtain the distance D1 between the position B and the position O of the positioning base station, and then, the mobile robot moving to the position A communicates with the positioning base station through the wireless ranging sensor so as to obtain the distance D2 between the position A and the position O of the positioning base station. The coordinate offset of the position A relative to the position B in the global coordinate system shown in FIG. 2 is measured by the odometer, that is, when the mobile robot moves to the position A from the position B, if the travel distance, measured by the odometer, of the mobile robot in the X-axis negative direction is a linear distance Dx, and meanwhile, the travel distance, measured by the odometer, of the mobile robot in the Y-axis positive direction is a linear distance Dy, it is indicated that the mobile robot has moved to the position A. In some specific implementation scenarios, there is an obstacle blocking between the position A and the position B, and thus, the mobile robot bypasses the obstacle (not shown in the figure) from the position B to travel to the position A.

As shown in FIG. 2, the mobile robot moves to the position A from the position B. In this embodiment, the start position of the actual travel path of the mobile robot is the position B, and the final position of the actual travel path of the mobile robot is the position A. In order to obtain coordinates of the position A, this embodiment constructs, without combining a result of trigonometric calculation on the distance information of the odometer and the angle information of the gyroscope, a system of two-variable equations with the coordinates of the position A (x0, y0) as unknown quantities based on the distances between the positions B and A where the mobile robot travels successively and the position O of the same positioning base station, and the coordinate offset of the position A relative to the position B, thereby calculating the coordinates of the final position of the actual travel path of the mobile robot.

Specifically, (x0+Dx)²+(y0−1−Dy)²=D1² can be constructed according to a line segment BO corresponding to the distance between the position B of the actual travel path of the mobile robot and the position O of the positioning base station, the coordinate offset Dx in the X-axis direction and the coordinate offset Dy in the Y-axis direction; meanwhile X0²+y0²=D2² can be constructed according to a line segment AO corresponding to the distance between the position A of the actual travel path of the mobile robot and the position O of the positioning base station; then, the two relational expressions are simultaneously solved to calculate the two unknown quantities x0 and y0, such that coordinates of a latest position where the mobile robot travels are calculated, namely the coordinates of the position A, and then, coordinates of the position B are calculated by combining Dx and Dy measured by the odometer. A specific calculation method is a mathematical problem, which is not described in detail herein.

It is apparent that the formula is simpler than an operational formula for calculating current position coordinates of the robot in the Chinese patent No. CN111381586A, and there is no need to use the cosine law is to calculate the angle information.

As an embodiment, the positioning base station is further integrated with a charging base. Before the mobile robot positioning method is performed, if the mobile robot finishes dock charging on the charging base, the mobile robot is controlled to leave the charging base in a second preset coordinate axis direction, and then, the mobile robot is controlled to rotate, such that a travel direction of the mobile robot is parallel to the first preset coordinate axis direction, where the first preset coordinate axis direction is perpendicular to the second preset coordinate axis direction. As shown in FIG. 2, the second preset coordinate axis direction is the Y-axis positive direction, and the first preset coordinate axis direction is the X-axis negative direction. In this embodiment, when the mobile robot returns to the positioning base station, the mobile robot can accurately dock to the charging base in an infrared alignment manner, thereby realizing recharging. The mobile robot can reset the measured angle when moving onto the charging base, such that when the mobile robot leaves the base and advances outwards, the fixed angle is kept. In this embodiment, the outward angle is generally set to be 90 degrees after base leaving, specifically, deflecting is performed by 90 degrees relative to the X-axis positive direction of the global coordinate system in FIG. 2, that is, the mobile robot may linearly move, in the Y-axis positive direction, deviating from the X-axis positive direction of the global coordinate system by 0 or 90 degrees, and then when a positioning algorithm is required to be performed, anticlockwise rotation by 90 degrees starts, and positioning calculation starts according to the embodiment in FIG. 2 Calculation of the actual position of the mobile robot can be simplified. It is to be explained that the position of the positioning base station may serve a preset initial horizontal ground position where the mobile robot performs the positioning algorithm, and may also serve a recharge position for the mobile robot.

In the above embodiment, when the first preset coordinate axis is the X-axis, the second preset coordinate axis is the Y-axis, the first preset coordinate axis direction includes the X-axis positive direction or X-axis negative direction, and the second preset coordinate axis direction includes the Y-axis positive direction or Y-axis negative direction; and when the first preset coordinate axis is the Y-axis, the second preset coordinate axis is the X-axis, the first preset coordinate axis direction includes the Y-axis positive direction or Y-axis negative direction, and the second preset coordinate axis direction includes the X-axis positive direction or X-axis negative direction The application scenarios of the positioning method in the above embodiments are expanded, and the coordinate calculation complexity is reduced.

Preferably, infrared alignment information carried by the charging base includes at least one of an identification code, frequency band information of an infrared guidance signal, an infrared narrow angle or infrared proximity signal. The charging base further carries identifying information, such that when the mobile robot enters an identification area, the identifying information is acquired by sensors (including the above first wireless ranging sensor) to position the charging base. The identifying information carried by the charging base may include a plurality of kinds of identifying information, and a specific type may be decided according to the type of a single-line ranging sensor arranged on the robot. For example, if the robot is provided with laser radar, the identifying information carried by the charging base may be a radar identification code; and if the mobile robot is provided with the UWB tag, the positioning base station may recognize a UWB ultra-wide band signal.

As another embodiment, as shown in FIG. 3, a global coordinate system is established with the position of the positioning base station as an origin O, and when the mobile robot travels to an area pointed by an X-axis positive direction and uses one positioning base station at the origin for positioning, the position D (x1−Dx1, y1−Dy1) is a position traversed by the mobile robot, and the position C (x1, y1) is an expected target position reached by the mobile robot as the mobile robot starts to travel to the area in the X-axis positive direction from the position D. Firstly, the mobile robot at the position D communicates with the positioning base station at the position O through the wireless ranging sensor so as to obtain the distance D3 between the position D and the position O of the positioning base station, and then, the mobile robot moving to the position C communicates with the positioning base station through the wireless ranging sensor so as to obtain the distance D4 between the position C and the position O of the positioning base station. The coordinate offset of the position C relative to the position D in the global coordinate system shown in FIG. 3 is measured by the odometer, that is, when the mobile robot moves to the position C from the position D, if the travel distance, measured by the odometer, of the mobile robot in the X-axis positive direction is a linear distance Dx1, and meanwhile, the travel distance, measured by the odometer, of the mobile robot in the Y-axis positive direction is a linear distance Dy1, it is indicated that the mobile robot has moved to the position C. In some specific implementation scenarios, there is an obstacle blocking between the position D and the position C, and thus, the mobile robot bypasses the obstacle (not shown in the figure) from the position D to travel to the position C.

As shown in FIG. 2, the mobile robot moves to the position C from the position D. In this embodiment, the start position of the actual travel path of the mobile robot is the position D, and the final position of the actual travel path of the mobile robot is the position C. In order to obtain coordinates of the position C, this embodiment constructs, without combining a result of trigonometric calculation on the distance information of the odometer and the angle information of the gyroscope, a system of two-variable equations with the coordinates of the position C (x1, y1) as unknown quantities based on the distances between the positions D and C where the mobile robot travels successively and the position O of the same positioning base station, and the coordinate offset of the position C relative to the position D, thereby calculating the coordinates of the final position of the actual travel path of the mobile robot.

Specifically, (x1−Dx1)²+(y1−Dy1)²=D3² can be constructed according to a line segment DO corresponding to the distance between the position D of the actual travel path of the mobile robot and the position O of the positioning base station, the coordinate offset Dx1 in the X-axis positive direction and the coordinate offset Dy1 in the Y-axis positive direction; meanwhile, x1²+y1²=D4² can be constructed according to a line segment CO corresponding to the distance between the position C of the actual travel path of the mobile robot and the position O of the positioning base station; then, the two relational expressions are simultaneously solved to calculate the two unknown quantities x1 and y1, such that coordinates of a latest position where the mobile robot travels are calculated, namely the coordinates of the position C, and then, coordinates of the position D are calculated by combining Dx1 and Dy1 measured by the odometer. A specific calculation method is a mathematical problem, which is not described in detail herein.

As an abnormal processing embodiment, the robot in this embodiment is likely to be stuck. Specifically, in the process of communication ranging through the first wireless ranging sensor arranged on the mobile robot and the second wireless ranging sensor arranged in the positioning base station, if real-time coordinates of the mobile robot in the travel process calculated according to the position coordinate calculation method in the above embodiment are kept unchangeable, that is, the coordinate offset, recorded by the odometer, on the global coordinate system is zero, it is judged that the mobile robot is stuck, meanwhile, the distance between the mobile robot and the same positioning base station is kept unchangeable, then, the odometer of the mobile robot is controlled to stop counting, such that the distance information of the odometer cannot be accumulated, and accordingly distance calculation and coordinate position operation in the above embodiment do not continue. Accordingly, the data processing volume can be reduced in the abnormal processing process.

It is to be understood that the serial numbers of various steps in the above embodiments do indicate an execution sequence, and the execution sequence of various processes is determined according to functions and internal logics, which cannot limit an implementation process of the embodiments of the present disclosure.

FIG. 4 is a schematic diagram of a framework of a mobile robot positioning system disclosed by the present disclosure, and a specific implementation is as below: the mobile robot positioning system includes a mobile robot and a positioning base station. The mobile robot is provided with a first wireless ranging sensor and an odometer, and the positioning base station is integrated with a second wireless ranging sensor, and in some embodiments, may also be integrated with a charging base; and the mobile robot inside further includes a distance calculation unit and a coordinate position calculation unit.

The distance calculation unit is configured to respectively calculate distances between two different positions where the mobile robot travels successively and the same positioning base station through communication ranging of the first wireless ranging sensor arranged on the mobile robot and the second wireless ranging sensor arranged in the same positioning base station, and then transmit the distances to the coordinate position calculation unit. The first wireless ranging sensor is about to receive a pulse signal transmitted by the second wireless ranging sensor, and performs analysis to transmit the pulse signal to the distance calculation unit for distance calculation.

The coordinate position calculation unit is configured to calculate the latter position of the two different positions where the mobile robot travels successively based on the preset position of the positioning base station, the distances between the two different positions where the mobile robot travels successively and the position of the same positioning base station, and a numerical relationship, fed back by the odometer of the mobile robot, between coordinate offsets of the two different positions where the mobile robot travels successively, preferably calculate coordinates of a latest position where the mobile robot travels when the mobile robot performs the positioning operation in the above embodiment at the current position, and determine the calculated position coordinates as real-time coordinates of the mobile robot in a global map, where the two different positions where the mobile robot travels successively are both within an effective detection range of the positioning base station; the coordinates of the latest position where the mobile robot travels represent the latter of the two different positions where the mobile robot travels successively; and in the travel process of the mobile robot, the global map is constructed in the mobile robot in real time, and the global coordinate system is established on the global map based on the preset position of the positioning base station.

Compared with the prior art, in the present technical solution, a pair of wireless ranging sensors are added in a conventional inertial navigation system or recharge system, which solves the problems that positioning accuracy of inertial navigation is uncontrollable, and too many wireless base stations are arranged, and also reduces the position angle calculated amount; and the positioning system is implanted in the mobile robot, which is beneficial to improving positioning accuracy and navigation efficiency of the robot.

It is to be explained that the wireless ranging sensor used in this embodiment is the UWB (an ultra-wide band ranging sensor).

Preferably, the mobile robot is a visual robot or laser robot. The coordinate position calculation unit arranged inside is configured to construct a system of two-variable equations with the coordinates of the final position as unknown quantities based on the distances between the two different positions where the mobile robot travels successively and the position of the same positioning base station and the coordinate offset of the final position relative to the start position, calculate the coordinates of the final position of the actual travel path of the mobile robot, and determine the calculated position coordinates as the real-time coordinates of the mobile robot in the global map; and when the mobile robot travels at the two different positions successively, the odometer of the mobile robot is controlled to record the coordinate offset of the final position of the actual travel path of the mobile robot relative to the start position, where the position where the mobile robot starts to travel is the start position of the actual travel path of the mobile robot, and a latest position for travel is the final position of the actual travel path of the mobile robot; the projection of the positioning base station on the travel plane of the mobile robot is the position of the positioning base station, and the global coordinate system is established with the position of the positioning base station as the origin; and the coordinate offsets of the above two different positions include an X-axis coordinate offset and a Y-axis coordinate offset of the global coordinate system.

Compared with the prior art, the coordinate position calculation unit constructs the equation set with line segment distance information as parameter variables in the global coordinate system based on the coordinate offset of the final position of the actual travel path of the mobile robot relative to the start position and the distance information between the two positions and the positioning base station, so as to make the calculated coordinates of the final position of the actual travel path of the mobile robot as the real-time position coordinates of the mobile robot, such that the positioning accuracy is controllable in various robot travel paths, and the problem that the inertial sensor is large in positioning error in the global coordinate system is solved.

It is to be explained that in the movement process of the robot, obstacle information in a scenario may also be collected in real time by one or more of a depth camera, radar and an ultrasonic sensor arranged on the mobile robot, and the robot can automatically avoid obstacles according to the collected obstacle information when advancing towards a target position, thereby improving flexibility of a manner of communication ranging between the mobile robot and the same positioning base station.

The mobile robot positioning system in FIG. 4 corresponds to the mobile robot positioning method based on wireless ranging sensors in FIG. 1.

The present disclosure further discloses a chip which is configured to store computer program code and may be arranged in the above mobile robot. The computer program code, when executed, implements the steps of the above mobile robot positioning method based on wireless ranging sensors. Or, the chip, when executing the computer program code, realizes functions of various units of the positioning system in the above embodiment. Exemplarily, the computer program code may be divided into one or more modules/units, and the one or more modules/units are stored in the chip and executed by the chip so as to finish this application. The one or more modules/units may be a series of computer program instruction segments capable of finishing specific functions, and the instruction segments are used for describing an execution process of the computer program code in the mobile robot. For example, the computer program code may be divided into: the distance calculation unit and the coordinate position calculation unit of the positioning system in the above embodiment. The positioning navigation accuracy of the mobile robot is controllable, and the coordinate position calculated amount is reduced.

Obviously, the above embodiments are merely examples for clear descriptions, but do not limit implementations. Those of ordinary skill in the art can make other different forms of changes or variations based on the above descriptions. It is neither necessary nor possible to exhaust all implementations. Obvious changes or variations expanded therefrom still fall within the scope of protection of the present disclosure.

What is claimed is:

1. A mobile robot positioning method based on wireless ranging sensors, comprising:
respectively calculating distances between two different positions where a mobile robot travels successively and a position of a positioning base station through communication ranging of a first wireless ranging sensor arranged on the mobile robot and a second wireless ranging sensor arranged in the same positioning base station, wherein when the mobile robot travels, a global map is constructed in the mobile robot in real time, and a global coordinate system is established on the global map based on a preset position of the positioning base station; and
calculating a latter position of the two different positions where the mobile robot travels successively based on a preset position of the positioning base station, the distances between the two different positions where the mobile robot travels successively and the position of the same positioning base station, and a numerical relationship which is between coordinate offsets of the two different positions where the mobile robot travels successively, and the numerical relationship is fed back by an odometer of the mobile robot, wherein the two different positions where the mobile robot travels successively are both within an effective detection range of the positioning base station, and the coordinate offsets are change information of the mobile robot travels successively within the two different positions, the numerical relationship is used to construct a distance numerical relational expression which is used to calculate the position coordinates of the a latter position of the two different positions.

2. The mobile robot positioning method according to claim 1, wherein calculating the latter position of the two different positions where the mobile robot travels successively based on the preset position of the positioning base station, the distances between the two different positions where the mobile robot travels successively and the position of the same positioning base station, and a numerical relationship which is between coordinate offsets of the two different positions where the mobile robot travels successively specifically comprises:
recording, by the odometer of the mobile robot, a coordinate offset of a final position of an actual travel path of the mobile robot relative to a start position, wherein a projection of the positioning base station on a travel plane of the mobile robot is the position of the positioning base station, the global coordinate system is established with the position of the positioning base station as an origin, and the coordinate offsets of the above two different positions comprise an X-axis coordinate offset and a Y-axis coordinate offset of the global coordinate system; and
then, constructing a system of two-variable equations with coordinates of the final position as unknown quantities based on the distances between the two different positions where the mobile robot travels successively and the position of the same positioning base station, and the coordinate offset of the final position relative to the start position so as to calculate the coordinates of the final position of the actual travel path of the mobile robot and determine the calculated position coordinates as real-time coordinates of the mobile robot in the global map.

3. The mobile robot positioning method according to claim 2, further comprising:
fusing the coordinates of the final position of the actual travel path of the mobile robot calculated based on the above system of two-variable equations, the distance information measured by the odometer of the mobile robot and angle information measured by a gyroscope of the mobile robot to filter noise generated by the first wireless ranging sensor and the second wireless ranging sensor during communication ranging, such that the calculated coordinates of the final position of the actual travel path of the mobile robot are subject to filtering,
wherein a triangular geometric relationship is utilized for calculating inertial coordinates of the mobile robot in the inertial navigation process according to the distance information measured by the odometer of the mobile robot and the angle information measured by the gyroscope of the mobile robot to participate in filtering operation on the coordinates of the above final position.

4. The mobile robot positioning method according to claim 3, wherein the first wireless ranging sensor is a UWB tag, and the second wireless ranging sensor is a UWB base station.

5. The mobile robot positioning method according to claim 3, wherein in the process of communication ranging through the first wireless ranging sensor arranged on the mobile robot and the second wireless ranging sensor arranged in the positioning base station, in a case that calculated real-time coordinates of the mobile robot in the travel process are kept unchangeable, it is judged that the mobile robot is stuck, and then the odometer of the mobile robot is controlled to stop counting.

6. The mobile robot positioning method according to claim 5, wherein the positioning base station is further integrated with a charging base; and
before the mobile robot positioning method is performed, in a case that the mobile robot finishes dock charging on the charging base, the mobile robot is first controlled to leave the charging base in a second preset coordinate axis direction, and then, the mobile robot is controlled to rotate, such that a travel direction of the mobile robot is parallel to a first preset coordinate axis direction,
wherein a first preset coordinate axis is perpendicular to a second preset coordinate axis, and a global coordinate system comprises the first preset coordinate axis and the second preset coordinate axis.

7. The mobile robot positioning method according to claim 6, wherein when the first preset coordinate axis is the X-axis, the second preset coordinate axis is the Y-axis, the first preset coordinate axis direction comprises an X-axis positive direction or X-axis negative direction, and the second preset coordinate axis direction comprises a Y-axis positive direction or Y-axis negative direction; and
when the first preset coordinate axis is the Y-axis, the second preset coordinate axis is the X-axis, the first preset coordinate axis direction comprises the Y-axis positive direction or Y-axis negative direction, and the second preset coordinate axis comprises the X-axis positive direction or X-axis negative direction.

8. The mobile robot positioning method according to claim 7, wherein the two different positions where the mobile robot travels successively are not located in a radial direction of a circular area with the position of the positioning base station as the circle center.

9. A mobile robot positioning system, comprising a mobile robot and a positioning base station, wherein the mobile robot is provided with a first wireless ranging sensor and an odometer, and the positioning base station is integrated with a second wireless ranging sensor; and
the mobile robot inside further comprises:
a distance calculation unit, configured to respectively calculate distances between two different positions where the mobile robot travels successively and the position of a positioning base station through communication ranging of the first wireless ranging sensor arranged on the mobile robot and the second wireless ranging sensor arranged in the same positioning base station; and
a coordinate position calculation unit, configured to calculate a latter position of the two different positions where the mobile robot travels successively based on a preset position of the positioning base station, the distances between the two different positions where the mobile robot travels successively and the position of the same positioning base station, and a numerical relationship which is between coordinate offsets of the two different positions where the mobile robot travels successively, and the numerical relationship is fed back by an odometer of the mobile robot, wherein the two different positions where the mobile robot travels successively are both within an effective detection range of the positioning base station, and the coordinate offsets are change information of the mobile robot travels successively within the two different positions, the numerical relationship is used to construct a distance numerical relational expression which is used to calculate the position coordinates of the a latter position of the two different positions;
wherein, in the travel process of the mobile robot, a global map is constructed in the mobile robot in real time, and a global coordinate system is established on the global map based on the preset position of the positioning base station.

10. The positioning system according to claim 9, wherein the mobile robot is a visual robot or laser robot, the coordinate position calculation unit arranged inside is configured to construct a system of two-variable equations with coordinates of the final position as unknown quantities based on the distances between the two different positions where the mobile robot travels successively and the position of the same positioning base station and the coordinate offset of the final position relative to the start position, calculate the coordinates of the final position of the actual travel path of the mobile robot, and determine the calculated position coordinates as real-time coordinates of the mobile robot in the global map; and
when the mobile robot travels at the two different positions successively, the odometer of the mobile robot is controlled to record the coordinate offset of the final position of the actual travel path of the mobile robot relative to the start position,
wherein the projection of the positioning base station on the travel plane of the mobile robot is the position of the positioning base station, the global coordinate system is established with the position of the positioning base station as the origin, and the coordinate offsets of the above two different positions comprise an X-axis coordinate offset and a Y-axis coordinate offset of the global coordinate system.

11. A chip, configured to store computer program code, wherein the computer program code, when executed, implements a mobile robot positioning method based on wireless ranging sensors, wherein the method comprises:
respectively calculating distances between two different positions where a mobile robot travels successively and a position of a positioning base station through communication ranging of a first wireless ranging sensor arranged on the mobile robot and a second wireless ranging sensor arranged in the same positioning base station, wherein when the mobile robot travels, a global map is constructed in the mobile robot in real time, and a global coordinate system is established on the global map based on a preset position of the positioning base station; and
calculating a latter position of the two different positions where the mobile robot travels successively based on a preset position of the positioning base station, the distances between the two different positions where the mobile robot travels successively and the position of the same positioning base station, and a numerical relationship which is between coordinate offsets of the two different positions where the mobile robot travels successively, and the numerical relationship is fed back by an odometer of the mobile robot, wherein the two different positions where the mobile robot travels successively are both within an effective detection range of the positioning base station, and the coordinate offsets are change information of the mobile robot travels successively within the two different positions, the numerical relationship is used to construct a distance numerical relational expression which is used to calculate the position coordinates of the a latter position of the two different positions.

12. The chip according to claim 11, wherein the method of calculating the latter position of the two different positions where the mobile robot travels successively based on the preset position of the positioning base station, the distances between the two different positions where the mobile robot travels successively and the position of the same positioning base station, and a numerical relationship, fed back by an odometer of the mobile robot, between coordinate offsets of the two different positions where the mobile robot travels successively specifically comprises the steps:
recording, by the odometer of the mobile robot, a coordinate offset of a final position of an actual travel path of the mobile robot relative to a start position, wherein a projection of the positioning base station on a travel plane of the mobile robot is the position of the positioning base station, the global coordinate system is established with the position of the positioning base station as an origin, and the coordinate offsets of the above two different positions comprise an X-axis coordinate offset and a Y-axis coordinate offset of the global coordinate system; and
then, constructing a system of two-variable equations with coordinates of the final position as unknown quantities based on the distances between the two different positions where the mobile robot travels successively and the position of the same positioning base station, and the coordinate offset of the final position relative to the start position so as to calculate the coordinates of the final position of the actual travel path of the mobile robot and determine the calculated position coordinates as real-time coordinates of the mobile robot in the global map.

13. The chip according to claim 12, the method further comprising:
fusing the coordinates of the final position of the actual travel path of the mobile robot calculated based on the above system of two-variable equations, the distance information measured by the odometer of the mobile robot and angle information measured by a gyroscope of the mobile robot to filter noise generated by the first wireless ranging sensor and the second wireless ranging sensor during communication ranging, such that the calculated coordinates of the final position of the actual travel path of the mobile robot are subject to filtering,
wherein a triangular geometric relationship is utilized for calculating inertial coordinates of the mobile robot in the inertial navigation process according to the distance information measured by the odometer of the mobile robot and the angle information measured by the gyroscope of the mobile robot to participate in filtering operation on the coordinates of the above final position.

14. The chip according to claim 13, wherein the first wireless ranging sensor is a UWB tag, and the second wireless ranging sensor is a UWB base station.

15. The chip according to claim 13, wherein in the process of communication ranging through the first wireless ranging sensor arranged on the mobile robot and the second wireless ranging sensor arranged in the positioning base station, in a case that calculated real-time coordinates of the mobile robot in the travel process are kept unchangeable, it is judged that the mobile robot is stuck, and then the odometer of the mobile robot is controlled to stop counting.

16. The chip according to claim 15, wherein the positioning base station is further integrated with a charging base; and
before the mobile robot positioning method is performed, in a case that the mobile robot finishes dock charging on the charging base, the mobile robot is first controlled to leave the charging base in a second preset coordinate axis direction, and then, the mobile robot is controlled to rotate, such that a travel direction of the mobile robot is parallel to a first preset coordinate axis direction,
wherein a first preset coordinate axis is perpendicular to a second preset coordinate axis, and a global coordinate system comprises the first preset coordinate axis and the second preset coordinate axis.

17. The chip according to claim 16, wherein when the first preset coordinate axis is the X-axis, the second preset coordinate axis is the Y-axis, the first preset coordinate axis direction comprises an X-axis positive direction or X-axis negative direction, and the second preset coordinate axis direction comprises a Y-axis positive direction or Y-axis negative direction; and
when the first preset coordinate axis is the Y-axis, the second preset coordinate axis is the X-axis, the first preset coordinate axis direction comprises the Y-axis positive direction or Y-axis negative direction, and the second preset coordinate axis comprises the X-axis positive direction or X-axis negative direction.

18. The chip according to claim 17, wherein the two different positions where the mobile robot travels successively are not located in a radial direction of a circular area with the position of the positioning base station as the circle center.
